(19) United States
(12) Patent Application Publication
(10) Pub. No.: US 2025/0301950 A1
(43) Pub. Date: Oct. 2, 2025

(54) MOWER DECK WITH ROCKER SUSPENSION

(71) Applicant: FireFly Automatix, Inc., Salt Lake City, UT (US)

(72) Inventors: Eric E. Aston, Farmington, UT (US); Mark C. LeBlanc, Salt Lake City, UT (US); Jamie Hughes, Herriman, UT (US); Sam B. Jensen, Farmington, UT (US); Cole Laulis, Murray, UT (US)

(21) Appl. No.: 18/620,337

(22) Filed: Mar. 28, 2024

(51) Int. Cl. A01D 34/62; A01D 101/00

(52) U.S. Cl. CPC A01D 34/62; A01D 2101/00

(57) ABSTRACT

A mower deck can include a rocker suspension that enables a more uniform cut even when the ground is bumpy. The rocker suspension can include opposing rocker members that are coupled to a support assembly via a pivot point. The opposing rocker members can support front and rear rollers or other rolling mechanisms. When the front or rear rollers encounter a bump, the rocker members can rotate around the pivot point to minimize the vertical displacement of a cutting unit. The front and/or rear rollers may be part of a roller assembly that forms a secondary rocker suspension.

### CROSS-REFERENCE TO RELATED APPLICATIONS

N/A

### BACKGROUND

Mower decks, particularly of industrial or commercial mowers, have front and rear rollers. For example, FIG. 1 shows a mower deck 10 having a housing 20 that is supported off the ground by a front roller 22 and a rear roller 23. Mower deck 10 includes a cutting unit in the form of a reel 21 but cutting unit(s) in the form of rotary blades are also oftentimes used.

### BRIEF SUMMARY

Embodiments of the present disclosure extend to a mower deck with rocker suspension. The rocker suspension enables a more uniform cut even when the ground is bumpy. The rocker suspension can include opposing rocker members that are coupled to a support assembly via a pivot point. The opposing rocker members can support front and rear rollers or other rolling mechanisms. When the front or rear rollers encounter a bump, the rocker members can rotate around the pivot point to minimize the vertical displacement of a cutting unit. The front and/or rear rollers or other rolling mechanisms may be part of an assembly that forms a secondary rocker suspension.

In some embodiments, a mower deck may include a support assembly, a cutting unit and a rocker suspension. The rocker suspension may include opposing rocker members, a front roller assembly comprising one or more front rollers, and a rear roller assembly comprising one or more rear rollers. The opposing rocker members may each be coupled to the support assembly via a pivot point. The cutting unit may be supported between the opposing rocker members. The front roller assembly may be coupled between the opposing rocker members at a front coupling point of each of the opposing rocker members. The rear roller assembly may be coupled between the opposing rocker members at a rear coupling point of each of the opposing rocker members. Each of the opposing rocker members may be configured to rotate relative to the support assembly at the respective pivot point.

In some embodiments, the pivot point may be positioned between the front coupling point and the rear coupling point of the respective rocker member.

In some embodiments, the pivot point may be positioned closer to the front coupling point than the rear coupling point.

In some embodiments, the pivot point, the front coupling point, and the rear coupling point of each rocker member may form a triangle.

In some embodiments, the front roller assembly may include a single front roller and the rear roller assembly may include a leading rear roller and a trailing rear roller.

In some embodiments, the rear roller assembly may form a secondary rocker suspension that includes opposing secondary rocker members that are coupled to the rocker members at the rear coupling point. The secondary rocker suspension may also include a leading rear roller and a trailing rear roller that are supported between the opposing secondary rocker members on leading and trailing sides respectively of the rear coupling point. The opposing secondary rocker members may be configured to rotate relative to the rocker members at the rear coupling point.

In some embodiments, the front roller assembly may form a secondary rocker suspension that includes opposing secondary rocker members that are coupled to the rocker members at the front coupling point. The secondary rocker suspension may also include a leading front roller and a trailing front roller that are supported between the opposing secondary rocker members on leading and trailing sides respectively of the front coupling point. The opposing secondary rocker members may be configured to rotate relative to the rocker members at the rear coupling point.

In some embodiments, a mower deck may include a support assembly, a cutting unit and a rocker suspension. The rocker suspension may include opposing rocker members, one or more front rolling mechanisms, and one or more rear rolling mechanisms. The opposing rocker members may each have a pivot point, a front coupling point and a rear coupling point. Each rocker member may be coupled to the support assembly via the pivot point. The cutting unit may be supported between the rocker members. Each of the one or more front rolling mechanisms may be coupled to one or both of the opposing rocker members via the front coupling point. Each of the one or more rear rolling mechanisms may be coupled to one or both of the opposing rocker members via the rear coupling point. Each of the opposing rocker members may be configured to rotate relative to the support assembly at the respective pivot point.

In some embodiments, the one or more front rolling mechanisms may comprise a front roller that is coupled between the opposing rocker members at the front coupling points and the one or more rear rolling mechanisms may comprise a leading rear roller and a trailing rear roller.

In some embodiments, the leading rear roller and the trailing rear roller may be coupled together via opposing secondary rocker members and the opposing secondary rocker members may be coupled to the opposing rocker members at the rear coupling point.

In some embodiments, the opposing rocker members may comprise a left rocker member and a right rocker member, and the one or more front rolling mechanisms may comprise one or more front left wheels that are coupled to the left rocker member via the front coupling point and one or more front right wheels that are coupled to the right rocker member via the front coupling point.

In some embodiments, the opposing rocker members may comprise a left rocker member and a right rocker member, and the one or more rear rolling mechanisms may comprise one or more rear left wheels that are coupled to the left rocker member via the rear coupling point and one or more rear right wheels that are coupled to the right rocker member via the rear coupling point.

In some embodiments, the cutting unit may be a reel or one or more rotary blades.

In some embodiments, a mower may include at least one mower deck. Each mower deck may include a support assembly, a cutting unit and a rocker suspension. The rocker suspension may include opposing rocker members, a front roller assembly comprising one or more front rollers, and a rear roller assembly comprising one or more rear rollers. The opposing rocker members may each be coupled to the support assembly via a pivot point. The cutting unit may be supported between the opposing rocker members. The front roller assembly may be coupled between the opposing rocker members at a front coupling point of each of the opposing rocker members. The rear roller assembly may be coupled between the opposing rocker members at a rear coupling point of each of the opposing rocker members. Each of the opposing rocker members may be configured to rotate relative to the support assembly at the respective pivot point.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features can be obtained, a more particular description will be rendered by reference to specific embodiments which are illustrated in the appended drawings. These drawings depict only typical embodiments and are not therefore to be considered to be limiting.

FIG. 1 illustrates a prior art mower deck that has front and rear rollers;

FIGS. 2A-2C are views of a mower deck that includes a rocker suspension in accordance with one or more embodiments of the present disclosure;

FIG. 3 is a block diagram representing a mower deck that includes a rocker suspension in accordance with one or more embodiments of the present disclosure;

FIGS. 3A-3D provide an example of how the rocker suspension may function in accordance with one or more embodiments of the present disclosure;

FIGS. 4A and 4B provide an example of how a secondary rocker suspension may be used in conjunction with a rocker suspension in accordance with one or more embodiments of the present disclosure.

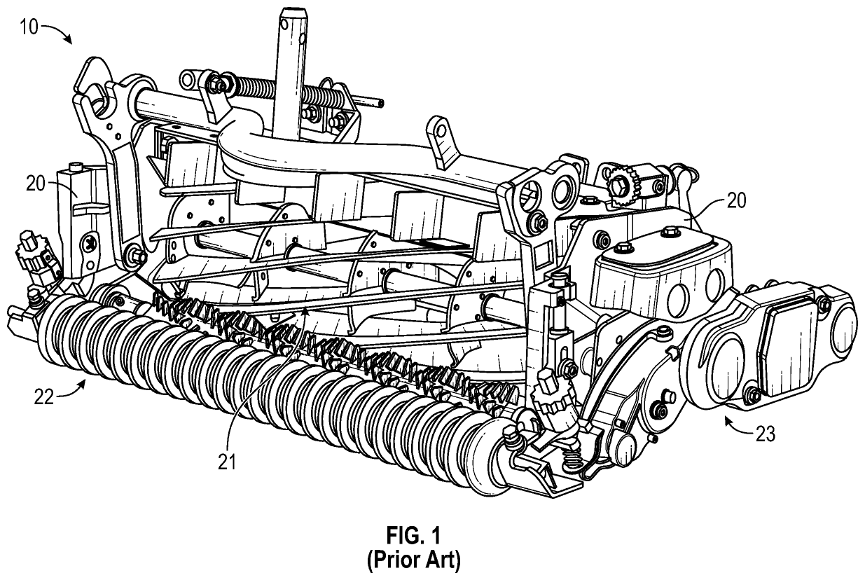

### DETAILED DESCRIPTION

A rocker suspension configured in accordance with embodiments of the present disclosure can be used on a variety of mower decks including mower decks with different types of cutting units such as rotary blade(s) or a reel. A mower may include one or more mower decks with a rocker suspension. For example, a large mower used to cut golf courses, stadiums, parks, sod farms, etc. could include multiple mower decks each of which includes a rocker suspension configured in accordance with embodiments of the present disclosure. As another example, a lawn mower may include a single mower deck having the rocker suspension configured in accordance with embodiments of the present disclosure.

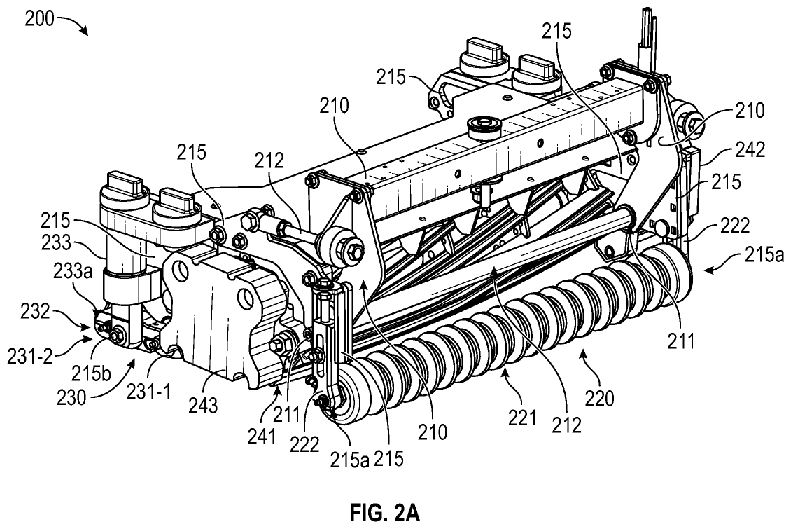

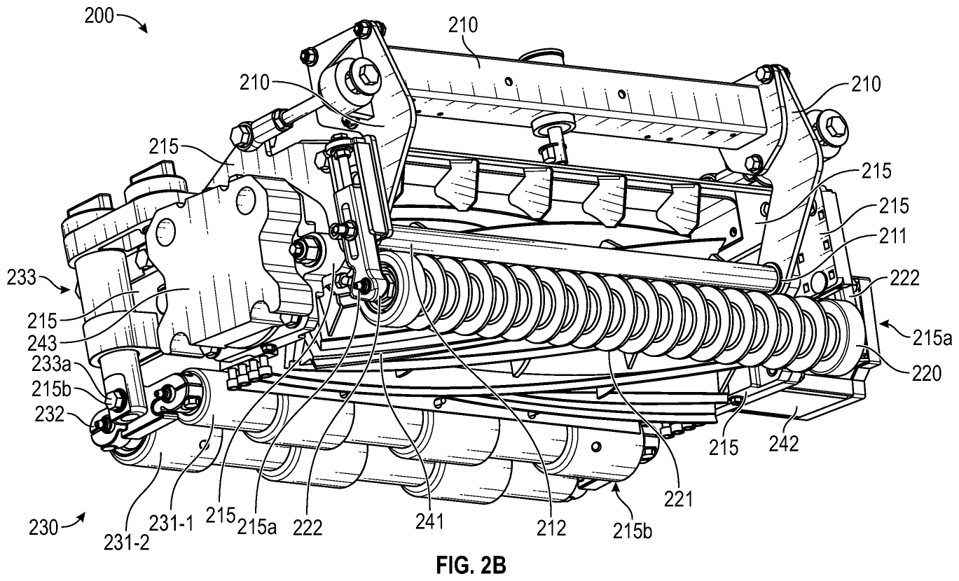

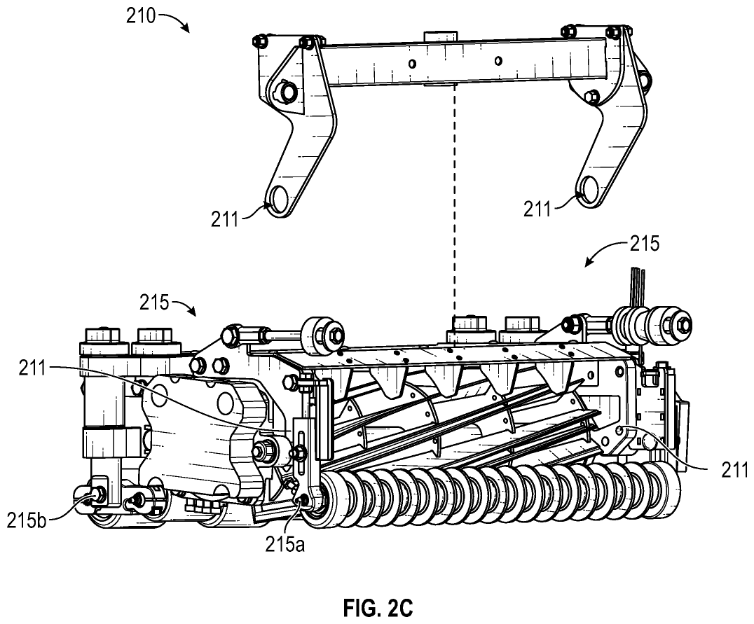

FIGS. 2A-2C provide an example of a mower deck 200 that may include a rocker suspension in accordance with one or more embodiments of the present disclosure. Mower deck 200 includes a support assembly 210 by which mower deck 200 is coupled to a mower. For example, a mower may be in the form of a tractor or vehicle and support assembly 210 may be coupled to arms or another suitable mechanism by which mower deck 200 may be raised and lowered relative to the ground.

Mower deck 200 also includes a rocker suspension that is formed by opposing rocker members 215, a front roller assembly 220 that may include one or more front rollers 221, and a rear roller assembly 230 that may include one or more rear rollers 231 (which includes rear rollers 231-1 and 231-2 in the depicted embodiment). The term “rocker member” is intended to represent the structural component(s) that support one end of a cutting unit (or units) 241, front roller(s) 221 and rear roller(s) 231 and that are coupled to support assembly 210 via a pivoting connection at a pivot point 211. In other words, rocker members 215 and therefore front roller(s) 221 and rear roller(s) 231 are configured to rotate relative to support assembly 210 via pivot point 211. A support rod 212 could extend between pivot points 211 in some embodiments. Pivot point 211 can be between a front coupling point 215a of front roller(s) 221 and a rear coupling point 215b of rear roller(s) 231. In some embodiments, opposing rocker members 215 could be formed from a common component such as a U-shaped frame.

FIG. 2C shows support assembly 210 separate from the remainder of mower deck 200 to better illustrate how the remainder of mower deck 200 can rotate relative to support assembly 210 at pivot point 211. As can be seen, in these embodiments, each rocker member 215 of mower deck 200 is formed by multiple interconnected components. However, much simpler and even more complex designs could be employed for rocker members 215.

In the depicted embodiments, a front roller assembly 220 includes a single front roller 221 and a height adjustment mechanism 222 that forms part of rocker member 215. Height adjustment mechanism 222 forms front coupling point 215a and can allow the height of front roller 221 relative to cutting unit 234 to be adjusted. A motor 242 and a counterbalance 243 are secured to opposing sides of mower deck 200 (e.g., by being mounted to opposing rocker members 215).

In the depicted embodiments, a rear roller assembly 230 includes rear rollers 231-1 and 231-2 and a height adjustment mechanism 233 that forms part of rocker member 215. Height adjustment mechanism 233 forms rear coupling point 215b and can allow the height of rear roller(s) 231 relative to cutting unit 241 to be adjusted.

In the depicted embodiments, rear roller assembly 230 forms a secondary rocker suspension. In particular, rear roller assembly 230 includes secondary rocker members 232 that support rear rollers 231-1 and 231-2 and that forms a secondary pivot point at rear coupling point 215b. In other words, secondary rocker members 232 and therefore rear rollers 231-1 and 231-2 are configured to rotate relative to rocker members 215 around rear coupling point 215b. In some embodiments, front roller assembly 220 could form this type of secondary rocker suspension instead of or in addition to rear roller assembly 230. In other embodiments, rear roller assembly 230 could include a single rear roller 231 that is coupled to height adjustment mechanism 233 at rear coupling point 215b similar to front roller assembly 230 as depicted. The secondary rocker suspension will be described further below.

Pivot point 211, front coupling point 215a and rear coupling point 215b can form a triangular shape. In the depicted embodiments, pivot point 211 is positioned closer to front coupling point 215a than to rear coupling point 215b. However, in some embodiments, pivot point 211 may be positioned at an equal distance between front coupling point 215a and rear coupling point 215b or closer to rear coupling point 215b.

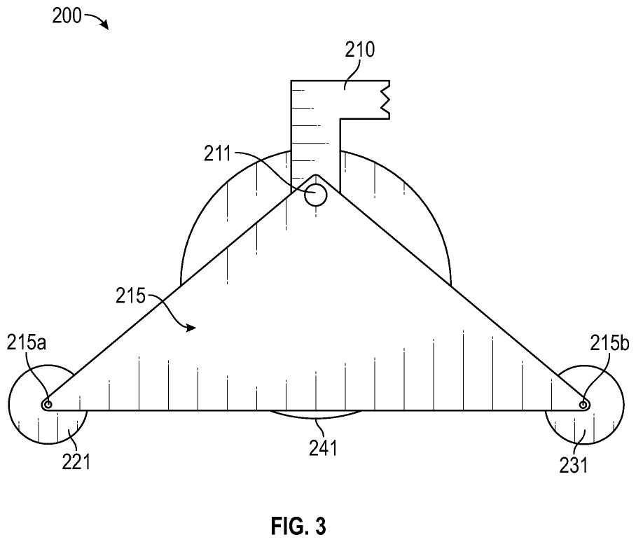

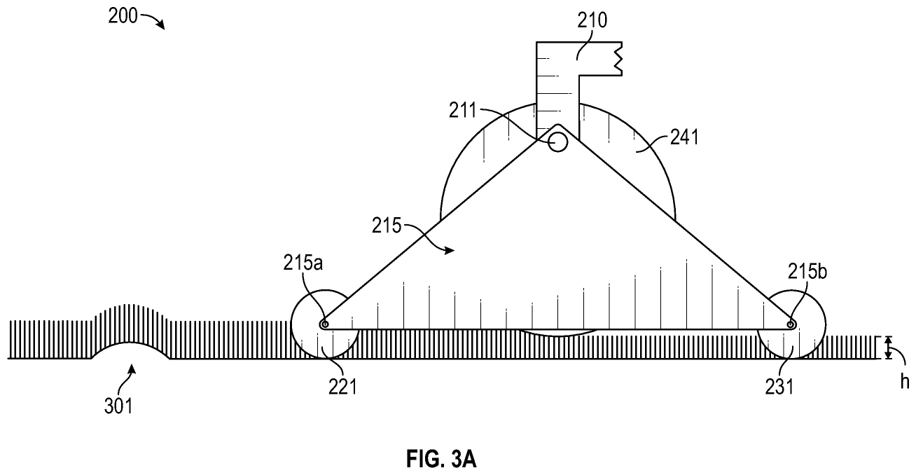

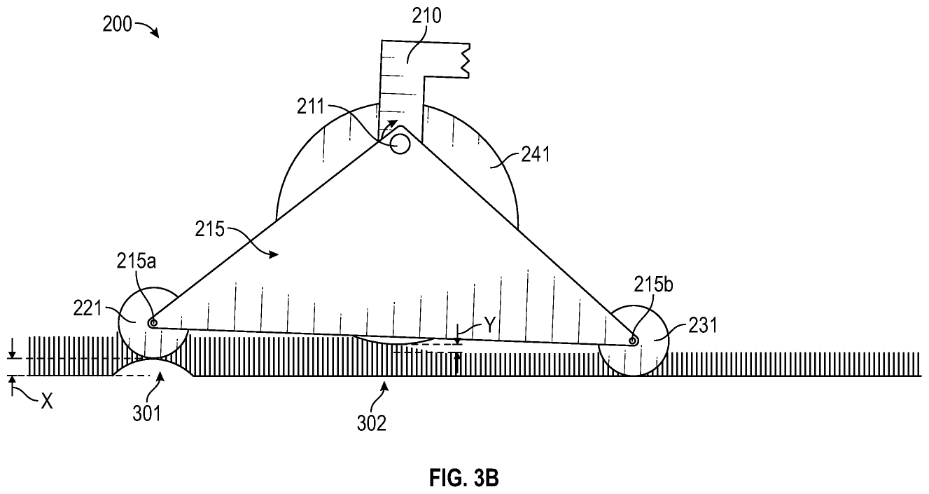

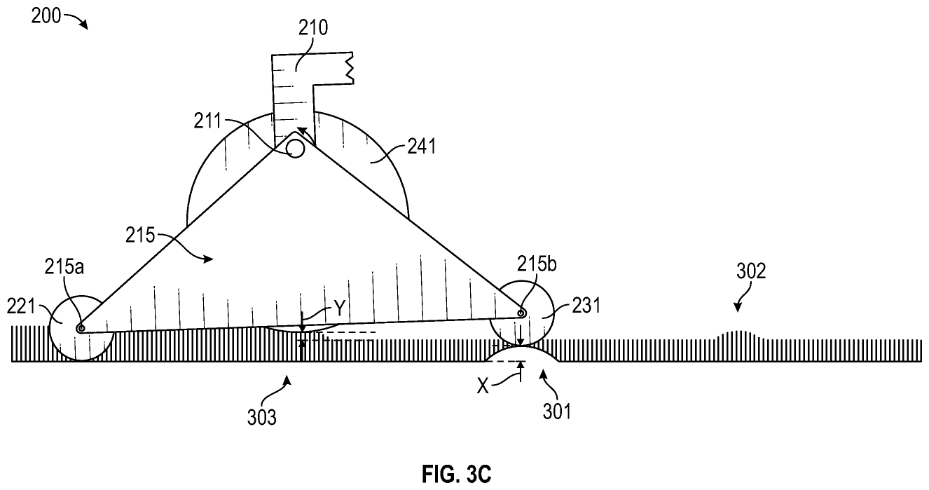

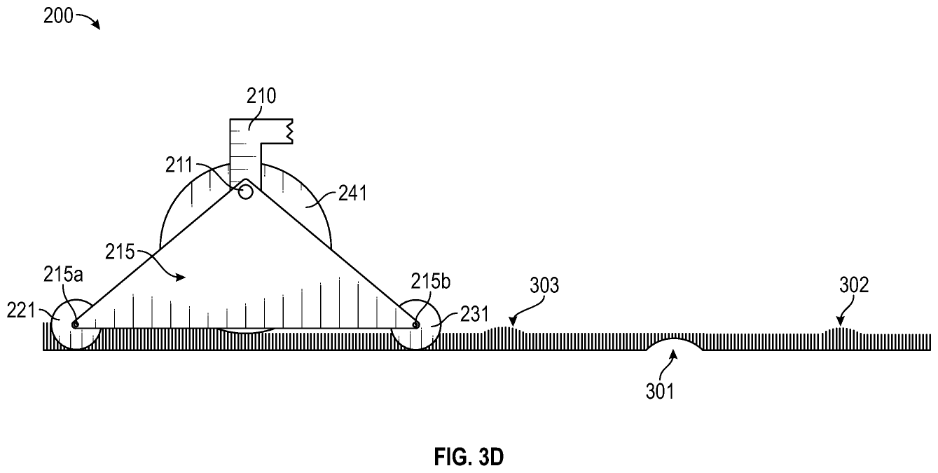

FIG. 3 is a simplified diagram of a mower deck 200 that includes a rocker suspension configured in accordance with embodiments of the present disclosure. FIGS. 3A-3D provide an example in the context of the simplified diagram of FIG. 3 of how a rocker suspension can be used on a mower deck to improve the cut of grass when a field is uneven. Although the shape of rocker members 215 in FIGS. 3A-3D differs from the shape of rocker members 215 in FIGS. 2A-2C, the functionality represented in FIGS. 3A-3D can be accomplished using any rocker suspension that is configured in accordance with embodiments of the present disclosure.

Turning to FIG. 3A, mower deck 200 is shown travelling from right to left and is approaching a bump 301. Cutting unit 241 is configured to cut the grass at a height h.

Turning to FIG. 3B, mower deck 200 has continued to travel to the point that front roller 221 is on top of bump 301. As front roller 221 travels up bump 301, the front of rocker members 215 (i.e., at front coupling point 215a) will be lifted relative to the cutting plane a distance equal to the height x of bump 301. In contrast, because rocker members 215 are coupled to support assembly 210 via pivot point 211, this lifting at the front of rocker members 215 will cause rocker members 215 to rotate around pivot point 211 as represented by the arrow. Due to the rotation of rocker members 215, the height of cutting unit 241 relative to the ground, and therefore the cutting height h, will be increased by an amount y that is less than the height x of bump 301. In other words, the rotation of rocker member 215 around pivot point 211 causes a smaller vertical displacement at pivot point 211 (which may be equal to y) compared to the vertical displacement at front coupling point 215a (which is equal to x). For example, if pivot point 211 and cutting unit 241 are centered between front coupling point 215a and rear coupling point 215b, the amount y may be half of the height x of bump 301. As a result, a section 302 of grass having an increased height will be formed but this increase will be minimized.

Turning to FIG. 3C, mower deck 200 has continued to travel to the point that rear roller 231 is on top of bump 301. As rear roller 231 travels up bump 301, the rear of rocker members 215 (i.e., at rear coupling point 215b) will be lifted relative to the cutting plane a distance equal to the height x of bump 301. In contrast, because rocker members 215 are coupled to support assembly 210 via pivot point 211, this lifting at the rear of rocker members 215 will cause rocker members 215 to rotate around pivot point 211 as represented by the arrow. The rotation in this case will be opposite the rotation when front roller 221 climbed bump 301. The cutting height will again be increased by an amount y that is less than the height x of bump 301 resulting in a section 303 of grass with increased height.

Turning to FIG. 3D, mower deck 200 has now traveled beyond bump 301. Due to the rocker suspension, the grass in sections 302 and 303 will be taller than the cutting height h but the increase in height is minimized. Accordingly, the field will appear to be more uniformly cut despite the presence of bump 301.

In the example, the amount y may be the same for sections 302 and 303 due to pivot point 211 and cutting unit 241 being centered between front coupling point 215a and rear coupling point 215b. However, this need not be the case. For example, if pivot point 211 and/or cutting unit 241 are offset towards front coupling point 215a (as in FIGS. 2A-2C) or rear coupling point 215b, the amount y may be different.

In some embodiments, a secondary rocker suspension may be used in addition to a rocker suspension to further minimize the amount of scalping or uneven cutting that may otherwise occur when the ground is bumpy. For example, if there is a steep dip or bump in the field, a secondary rocker suspension can smooth the transition over the dip or the bump. More particularly, rear rollers 231-1 and 231-2 are positioned frontward and rearward of rear coupling point 215b and can follow the contour of the ground by rotating around rear coupling point 215b. As a result, the height of rear coupling point 215b relative to the ground will not follow the contour at the vertical transitions but will follow a smoother (or less steep) path.

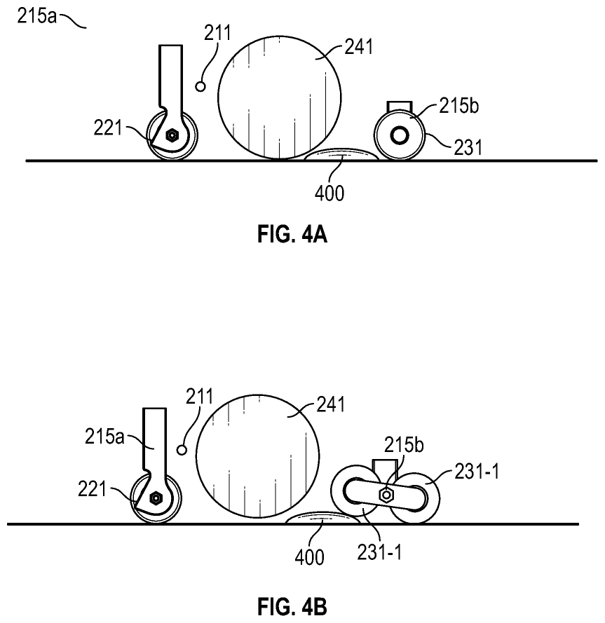

FIGS. 4A and 4B provide a simple example of how a secondary rocker suspension can smooth the transitions over uneven ground. In this example, an exaggerated bump 400 is depicted to better highlight the benefits of a secondary rocker suspension. FIG. 4A generally represents the rocker suspension of mower deck 200 in FIGS. 2A-2C except that rear roller assembly 230 includes a single rear roller 231 (i.e., it does not form a secondary rocker suspension). In FIG. 4A, rear roller 231 is approaching bump 400 and cutting unit 241 is very close to the trailing edge of bump 400 and therefore has scalped the grass.

In comparison, in FIG. 4B, rear roller assembly 230 forms a secondary rocker suspension and therefore generally represents the configuration of mower deck 200 in FIGS. 2A-2C. In this case, rear roller 231-1 reaches bump 400 and pivots upwardly around rear coupling point 215b which in turn causes cutting unit 241 to be lifted away from the trailing edge of bump 400. This lifting is facilitated by the rocker suspension because of the pivoting around pivot point 211 as described above. In FIG. 4B and due to the secondary rocker suspension, rear coupling point 215b is lifted earlier than in FIG. 4A and can therefore cease scalping earlier (or avoid it altogether). Likewise, as rear rollers 231-1 and 231-2 descend bump 400, rear coupling point 215b will not complete its descent until later than in FIG. 4A and can therefore avoid or minimize a noticeable ridge in the cut height that may otherwise occur. Simply put, the secondary rocker suspension spreads the curve that rear coupling point 215b (or front coupling point 215a) will travel when uneven terrain is encountered.

In some embodiments, and in addition to smoothing the transition, a secondary rocker suspension can minimize the amplitude of an uneven cut. Because a secondary rocker suspension includes rear rollers 231-1 and 231-2 on leading and trailing sides of rear coupling point 215b, rear coupling point 215b can be positioned closer to the ground than if a single rear roller 231 is used. In other words, the axes of rear rollers 231-1 and 231-2 can be higher than rear coupling point 215b. Therefore, when rear rollers 231-1 and 231-2 are on top of bump 400, rear coupling point 215b will be positioned above bump 400 at a vertical distance that is less than the radius of rear rollers 231-1 and 231-2. In comparison, rear coupling point 215b would be lifted a vertical distance equal to the radius of rear roller 231 when a single rear roller 231 is used. Simply put, a secondary rocker suspension can also flatten the curve that rear coupling point 215b (or front coupling point 215a) will travel when uneven terrain is encountered.

In summary, by providing a rocker assembly and/or a secondary rocker assembly, the mower deck, which is typically configured to “float” from the mower along the contour of the ground, can pivot as it traverses uneven contour so that the cutting unit follows smoother vertical transitions. As a result, a field can be cut more uniformly even if there are significant bumps or dips.

Although embodiments of the present invention have been described in the context of a mower deck having front and rear rollers, a rocker suspension configured in accordance with embodiments of the present invention could be used on a mower deck having front and rear wheels.

What is claimed:

1. A mower deck comprising:
a support assembly;
a cutting unit; and
a rocker suspension that includes:
opposing rocker members that are each coupled to the support assembly via a pivot point and between which the cutting unit is supported;
a front roller assembly comprising one or more front rollers, the front roller assembly being coupled between the opposing rocker members at a front coupling point of each of the opposing rocker members; and
a rear roller assembly comprising one or more rear rollers, the rear roller assembly being coupled between the opposing rocker members at a rear coupling point of each of the opposing rocker members;
wherein each of the opposing rocker members is configured to rotate relative to the support assembly at the respective pivot point.

2. The mower deck of claim 1, wherein the pivot point is positioned between the front coupling point and the rear coupling point of the respective rocker member.

3. The mower deck of claim 2, wherein the pivot point is positioned closer to the front coupling point than the rear coupling point of the respective rocker member.

4. The mower deck of claim 1, wherein the pivot point, the front coupling point, and the rear coupling point of each rocker member form a triangle.

5. The mower deck of claim 1, wherein the front roller assembly includes a single front roller and the rear roller assembly includes a leading rear roller and a trailing rear roller.

6. The mower deck of claim 1, wherein the rear roller assembly forms a secondary rocker suspension that includes opposing secondary rocker members that are coupled to the rocker members at the rear coupling point, the secondary rocker suspension also including a leading rear roller and a trailing rear roller that are supported between the opposing secondary rocker members on leading and trailing sides respectively of the rear coupling point, the opposing secondary rocker members being configured to rotate relative to the rocker members at the rear coupling point.

7. The mower deck of claim 1, wherein the front roller assembly forms a secondary rocker suspension that includes opposing secondary rocker members that are coupled to the rocker members at the front coupling point, the secondary rocker suspension also including a leading front roller and a trailing front roller that are supported between the opposing secondary rocker members on leading and trailing sides respectively of the front coupling point, the opposing secondary rocker members being configured to rotate relative to the rocker members at the rear coupling point.

8. A mower deck comprising:
a support assembly;
a cutting unit; and
a rocker suspension that includes:
opposing rocker members that each have a pivot point, a front coupling point and a rear coupling point, each rocker member being coupled to the support assembly via the pivot point, the cutting unit being supported between the rocker members;
one or more front rolling mechanisms, each of the one or more front rolling mechanisms being coupled to one or both of the opposing rocker members via the front coupling point; and
one or more rear rolling mechanisms, each of the one or more rear rolling mechanisms being coupled to one or both of the opposing rocker members via the rear coupling point;
wherein each of the opposing rocker members is configured to rotate relative to the support assembly at the respective pivot point.

9. The mower deck of claim 8, wherein the one or more front rolling mechanisms comprise a front roller that is coupled between the opposing rocker members at the front coupling points and the one or more rear rolling mechanisms comprise a leading rear roller and a trailing rear roller.

10. The mower deck of claim 9, wherein the leading rear roller and the trailing rear roller are coupled together via opposing secondary rocker members, the opposing secondary rocker members being coupled to the opposing rocker members at the rear coupling point.

11. The mower deck of claim 8, wherein the opposing rocker members comprise a left rocker member and a right rocker member, and the one or more front rolling mechanisms comprise one or more front left wheels that are coupled to the left rocker member via the front coupling point and one or more front right wheels that are coupled to the right rocker member via the front coupling point.

12. The mower deck of claim 8, wherein the opposing rocker members comprise a left rocker member and a right rocker member, and the one or more rear rolling mechanisms comprise one or more rear left wheels that are coupled to the left rocker member via the rear coupling point and one or more rear right wheels that are coupled to the right rocker member via the rear coupling point.

13. The mower deck of claim 8, wherein the pivot point is positioned closer to the front coupling point than the rear coupling point of the respective rocker member.

14. The mower deck of claim 8, wherein the pivot point, the front coupling point, and the rear coupling point of each rocker member form a triangle.

15. The mower deck of claim 8, wherein the cutting unit comprises a reel.

16. The mower deck of claim 8, wherein the cutting unit comprises one or more rotary blades.

17. The mower deck of claim 8, wherein the support assembly is configured to couple the mower deck to a mower.

18. A mower comprising:
at least one mower deck, each mower deck comprising:
a support assembly;
a cutting unit; and
a rocker suspension that includes:
opposing rocker members that are each coupled to the support assembly via a pivot point and between which the cutting unit is supported;
a front roller assembly comprising one or more front rollers, the front roller assembly being coupled between the opposing rocker members at a front coupling point of each of the opposing rocker members; and
a rear roller assembly comprising one or more rear rollers, the rear roller assembly being coupled between the opposing rocker members at a rear coupling point of each of the opposing rocker members;
wherein each of the opposing rocker members is configured to rotate relative to the support assembly at the respective pivot point.

19. The mower of claim 18, wherein the at least one mower deck comprises multiple mower decks.

20. The mower of claim 18, wherein the support assembly of each mower deck couples the respective mower deck to the mower.
